(19) United States
(12) Patent Application Publication
(10) Pub. No.: US 2008/0008784 A1
(43) Pub. Date: Jan. 10, 2008

(54) Animal attractant and nutritional supplement

(76) Inventor: Darrell Glenn Hedges, Sadler, TX (US)

Correspondence Address: LAW OFFICES OF ERIC KARICH, 2807 ST. MARK DR., MANSFIELD, TX, 76063, US

(21) Appl. No.: 11/445,853

(22) Filed: Jun. 3, 2006

(51) Int. Cl. A23L 1/30

(52) U.S. Cl. 426/72

(57) ABSTRACT

An animal attractant has a hard sugar/nutrient body, an insert, and a screw. The hard sugar/nutrient body includes a sugar and at least one water-soluble nutritional supplement. The insert is trapped a least partially within the hard sugar/nutrient body. The screw has a head and a threaded post, and the screw is positioned through the insert such that the head engages the insert and the threaded post extends at least partially out of the hard sugar/nutrient body.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to animal attractants, and more particularly to an animal attractant that includes a nutritional supplement and is adapted to be mounted on a tree or similar surface.

2. Description of Related Art

Various animal attractants are well known in the art. Common products for attracting animals such as deer include BUCK JAM™ and STUMP LIKKER™, both trademarks of Evolved Habitats, Inc. These products are sold in a liquid or gel form and contain molasses and nutritional supplements. These products are adapted to be poured on the ground, or a tree stump, to attract deer, as well as provide the deer with a nutritional supplement. The problem with providing the animal attractant in a liquid form is that they do not last very long, and they tend to be easily washed away by rain.

Other animal attractants include both molasses and nutritional supplements that are sold in a block form that is simply dropped on the ground and allowed to be eaten or eventually melt away. The problem with simply dropping a block on the ground is that animals carry the attractant off, so that animals are not drawn to the selected site.

The prior art teaches animal attractants that include molasses and nutritional supplements. However, the prior art does not teach an animal attractant that includes an insert and a screw for mounting the animal attractant on a tree or similar surface. The prior art also does not teach the present method of producing the animal attractant of the present invention. The present invention fulfills these needs and provides further related advantages as described in the following summary.

### SUMMARY OF THE INVENTION

The present invention teaches certain benefits in construction and use which give rise to the objectives described below.

The present invention provides an animal attractant and nutritional supplement comprising a hard sugar/nutrient body, an insert, and a screw. The hard sugar/nutrient body includes a sugar and at least one water-soluble nutritional supplement. The insert is trapped a least partially within the hard sugar/nutrient body. The screw has a head and a threaded post, and the screw is positioned through the insert such that the head engages the insert and the threaded post extends at least partially out of the hard sugar/nutrient body.

A primary objective of the present invention is to provide an animal attractant having advantages not taught by the prior art.

Another objective is to provide an animal attractant that includes an insert and a screw for mounting the animal attractant on a tree or similar surface.

A further objective is to provide a novel method of manufacturing an animal attractant.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of an animal attractant according to a preferred embodiment of the present invention, the animal attractant being positioned to be mounted on a tree;

FIG. 2 is an exploded perspective view of the animal attractant as it is being manufactured in a mold; and

FIG. 3 is a sectional view of the animal attractant taken along line 3-3 in FIG. 1.

### DETAILED DESCRIPTION OF THE INVENTION

The above-described drawing figures illustrate the invention, an animal attractant 10 that is adapted to lure animals such as deer, wild hogs, or any other form of animal, to a particular location for hunting, while simultaneously providing the animals with nutrients necessary for the healthy growth of the animals. In particular, the animal attractant 10 is provided in a hard form that will last for a greater length of time, and is adapted to be mounted on a tree or other structure so that the animal attractant 10 cannot be taken away by the animal.

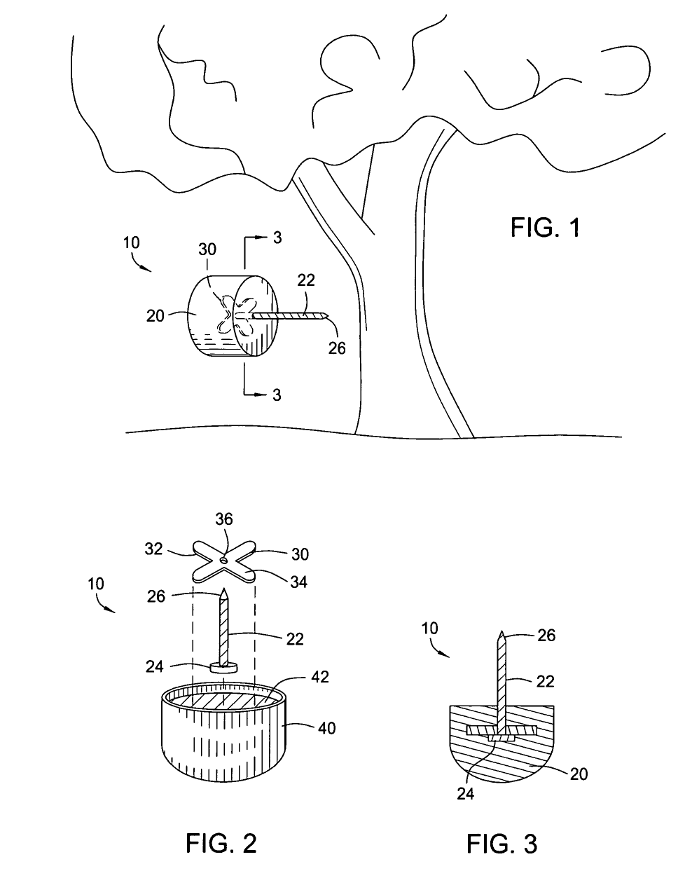

As shown in FIGS. 1-3, the animal attractant 10 includes a hard sugar/nutrient body 20, and a screw 22 that extends from the hard sugar/nutrient body 20 for mounting the hard sugar/nutrient body 20 on the tree.

The hard sugar/nutrient body 20 includes a sugar and at least one water-soluble nutritional supplement. The sugar may be in any form or composition known in the art, including molasses or other form that is easily and inexpensively produced. The nutritional supplement includes at least one of the following: a source of phosphate, a source of calcium, a source of magnesium, and a source of at least one vitamin. The nutritional supplement preferably includes all of these elements, and may further include additional elements, including diatomaceous earth for providing a natural cure for worms. A more detailed description of the manufacture of the hard sugar/nutrient body 20 is provided below.

The screw 22 preferably includes a head 24 and a threaded post 26. The screw 22 is positioned such that the head 24 is positioned within the hard sugar/nutrient body 20 such that at least part of the threaded post 26 extends out of the hard sugar/nutrient body 20. This enables the screw 22 to be used to mount the hard sugar/nutrient body 20 on the tree by screwing the threaded post 26 into the tree. For purposes of this application, the term “screw” shall be hereby defined to include similar, related, or equivalent elements for handing, fastening, or otherwise mounting the hard sugar/nutrient body 20 on a tree, post, or similar, related, or equivalent structure.

In the preferred embodiment, the animal attractant 10 further includes an insert 30 for anchoring the screw 22 in the hard sugar/nutrient body 20. The insert 30 preferably includes at least two radially extending fins 32 connected by a center portion 34 having a screw-receiving aperture 36. The insert 30 is positioned at least partially within the hard sugar/nutrient body 20 and the screw 22 is positioned through the screw-receiving aperture 36 such that the head 24 of the screw 22 engages the insert 30 and the screw 22 is anchored by the insert 30. The insert 30 functions to more securely anchor the screw 22 in the hard sugar/nutrient body 20, so that the hard sugar/nutrient body 20 cannot be easily torn from the tree or other structure by the animal(s) consuming the hard sugar/nutrient body 20.

The screw 22 is preferably a standard metal screw, although alternative and perhaps biodegradable materials could also be used, as long as they are suitably strong enough to penetrate into the tree. The insert 30 is constructed of a durable, rigid material such as plastic, strong paper or fiber, or other suitable material, and may include a plurality of fins for better anchoring the screw 22.

The invention further includes a method for manufacturing the animal attractant 10 described above. The hard sugar/nutrient body 20 is formed in a mold 40 using a novel process. First, a sugar solution is heated until the water content of the sugar solution is less than fifteen percent, forming a sugar paste. The sugar paste preferably has a water content of less than ten percent, most preferably two percent or less.

At least one nutritional supplement is then folded into the sugar paste to form a sugar/nutrient paste 42. As shown in FIG. 2, the screw 22 (and preferably the insert 30 as well) is then inserted into the sugar/nutrient paste 42. Finally, the sugar/nutrient paste 42 is then cooled in a dry environment until the sugar/nutrient paste 42 hardens into a sugar/nutrient body 20.

In the preferred embodiment, the step of heating the sugar/nutrient paste 42 includes heating the sugar/nutrient paste 42 at between 200-300 degrees until the water content is less than fifteen percent. In the preferred embodiment, the sugar/nutrient paste 42 is heated at about 250 degrees until the water content is less than ten percent, most preferably until the water content is two percent or less.

The terminology used in this application is hereby defined to include not only the words described above, but also similar or equivalent words, and derivatives thereof. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An animal attractant comprising:
a hard sugar/nutrient body having a sugar and at least one nutritional supplement; and
a screw having a head and a threaded post, the head of the screw being positioned within the hard sugar/nutrient body such that at least part of the threaded post extends out of the hard sugar/nutrient body.

2. The animal attractant of claim 1, wherein the at least one nutritional supplement includes at least one of the following: a source of phosphate, a source of calcium, a source of magnesium, and a source of at least one vitamin.

3. The animal attractant of claim 1, wherein the at least one nutritional supplement includes diatomaceous earth.

4. The animal attractant of claim 1, further comprising an insert that includes at least two radially extending fins connected by a center portion having a screw-receiving aperture, the insert being positioned within the hard sugar/nutrient body and the screw is positioned through the screw-receiving aperture.

5. The animal attractant of claim 3, wherein the insert is constructed of a durable, rigid material.

6. An animal attractant comprising:
a hard sugar/nutrient body having a sugar and at least one nutritional supplement;
an insert trapped a least partially within the hard sugar/nutrient body; and
a screw having a head and a threaded post, the screw being positioned through the insert such that the head engages the insert and the threaded post extends at least partially out of the hard sugar/nutrient body.

7. The animal attractant of claim 6, wherein the at least one nutritional supplement includes at least one of the following: a source of phosphate, a source of calcium, a source of magnesium, and a source of at least one vitamin.

8. The animal attractant of claim 6, wherein the insert includes at least two radially extending fins connected by a center portion having a screw-receiving aperture.

9. The animal attractant of claim 8, wherein the insert is constructed of a durable, rigid material.

10. The animal attractant of claim 9, wherein the insert is constructed of a rigid plastic.

11. The animal attractant of claim 6, wherein the at least one nutritional supplement includes diatomaceous earth.

12. A method for manufacturing an animal attractant, the method comprising the steps of:
providing a sugar solution;
heating the sugar solution until the water content of the sugar solution is less than fifteen percent, forming a sugar paste;
folding at least one nutritional supplement into the sugar paste to form a sugar/nutrient paste;
inserting a screw into the sugar/nutrient paste;
cooling the sugar/nutrient paste in a dry environment until the sugar/nutrient paste hardens into a sugar/nutrient body.

13. The method of claim 12, further comprising the steps of:
providing a mold having the screw positioned through an insert;
mixing the sugar paste and the at least one nutritional supplement in the mold, thereby forming the sugar/nutrient paste; and
positioning the insert in the sugar/nutrient paste so that the insert is at least partially covered by the sugar/nutrient paste but the screw extends from the sugar/nutrient paste.

14. The method of claim 12, wherein the at least one nutritional supplement includes at least one of the following: a source of phosphate, a source of calcium, a source of magnesium, and a source of at least one vitamin.

15. The method of claim 12, wherein the at least one nutritional supplement includes diatomaceous earth.

16. The method of claim 13, wherein the insert includes at least two radially extending fins connected by a center portion having a screw-receiving aperture.

17. The method of claim 13, wherein the screw has a head and a threaded post, and the screw is positioned through the screw-receiving aperture of the insert such that the head engages the insert and the threaded post extends at least partially out of the hard sugar/nutrient paste.

18. The method of claim 12, wherein the step of heating the sugar solution includes heating the sugar solution at between 200-300 degrees until the water content is less than ten percent.

19. The method of claim 12, wherein the step of heating the sugar solution includes heating the sugar solution at between 200-300 degrees until the water content is two percent or less.

20. The method of claim 12, wherein the step of heating the sugar solution includes heating the sugar solution at about 250 degrees until the water content is two percent or less.
